(19) United States
(12) Patent Application Publication
(10) Pub. No.: US 2015/0153851 A1
(43) Pub. Date: Jun. 4, 2015

(54) Flexible Pen in Narrow Garage

(71) Applicant: Dell Products, LP, Round Rock, TX (US)

(72) Inventors: Lawrence E. Knepper, Leander, TX (US); Deeder M. Aurongzeb, Austin, TX (US); John Trevor Morrison, Round Rock, TX (US); Patrick Hampton, Round Rock, TX (US); Michael David, Austin, TX (US); Sean P. O'Neal, Austin, TX (US)

(21) Appl. No.: 14/615,164

(22) Filed: Feb. 5, 2015

Related U.S. Application Data
(63) Continuation-in-part of application No. 13/789,898, filed on Mar. 8, 2013.

(51) Int. Cl. G06F 3/0354

(52) U.S. Cl. CPC G06F 3/03545

(57) ABSTRACT

Disclosed systems include an expandable diameter stylus including an elongated body, a writing surface disposed on an end of the elongated body, and a variable diameter sheath including a helical weave along at least a portion of the elongated body. Disclosed systems may also include an actuating structure to vary the length and diameter of the variable diameter sheath and the expandable diameter stylus.

### CROSS REFERENCE TO RELATED APPLICATIONS

This application is a continuation-in-part of U.S. patent application Ser. No. 13/789,898, entitled “Expandable Diameter Stylus,” filed on Mar. 8, 2013, the disclosure of which is hereby expressly incorporated by reference in its entirety.

### FIELD OF THE DISCLOSURE

This disclosure generally relates to dual display information handling systems having a one or more display platforms for visual transmission of information to a user, and more particularly relates to a flexible stylus pen for use with a display platform.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to he general or configured for a specific user or specific use such as clinical healthcare data storage and distribution, financial transaction processing, procurement, stocking and delivery tracking, provision of data services and software, airline reservations, enterprise data storage, or global communications. Information handling systems may include a variety of hardware and software components that may be configured to process, store, and communicate information and may include one or more computer systems, data storage systems, and networking systems. Additionally, information handling systems may have two or more display platforms with one or more display screens for output of images and for input such as by touch screen operation or active pen input.

Some portable information handling systems including tablets, notebook computers, and smartphones—utilize a pen or stylus as an input device. The terms pen and stylus may be used interchangeably herein. In some instances the stylus is stored in a garage on the system, so that a user has access to the stylus when desired and can safely store it when it is not in use. In other instances the stylus may be attached to a system in various ways. Unfortunately, with portability an important factor in tablet and notebook design, the profile of tablets and notebooks has been decreasing, limiting the space available for the garage and the stylus. Stylus input devices also are likely to decrease in size at the expense of usability and user comfort.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a diagram of an existing portable computing system.

FIGS. 2A-2C illustrates diagrams of an example expandable diameter stylus, according to aspects of the present disclosure.

FIGS. 3A and 3B illustrates diagrams of an example expandable diameter stylus, according to aspects of the present disclosure.

FIGS. 4A-4C illustrates diagrams of another example expandable diameter stylus, according to aspects of the present disclosure.

FIG. 5 illustrates a diagram of an example endcap structure according to aspects of the present disclosure.

FIG. 6 illustrates a block diagram with aspects of an information handling system according to an embodiment of the present disclosure.

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

### DETAILED DESCRIPTION

The following description in combination with the Figures is provided to assist in understanding the teachings disclosed herein. While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure, The use of the same reference symbols in different drawings indicates similar or identical items.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. Information handling systems have input systems for receiving user input. Input systems are used for entering data, making selections, and the like, Example input systems include a mouse, a keyboard, and an interactive display (e.g., touchscreen). In one scenario, a user provides input to an interactive display using a pointer. Example pointers include a finger, a stylus, or a digital pen. An example stylus is a pen-shaped cylinder with a rubberized tip. A stylus may be passive or active and include electronic systems (e.g., a location emitter) that work in conjunction with an information handling system for processing user input.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

In accordance with the present disclosure, an expandable diameter stylus and related systems and methods are described herein. The expandable diameter stylus may comprise an elongated body and a writing surface disposed on an end of the elongated body. The expandable diameter stylus may also include a variable diameter grip. The variable diameter grip may expand or contract along the entire length of the elongated body or along only a portion of the elongated body. In some example embodiments, the variable diameter grip may include a variable diameter sheath that may be the outermost layer of the expandable diameter stylus in certain embodiments. In an example embodiment, the variable diameter sheath may be a helical weave of material that may expand in diameter with a shorter length and contract in diameter with a longer length. The variable diameter sheath may not ultimately be the outer-most layer or coating on the expandable diameter stylus in other embodiments. As would be understood by one or ordinary skill, additional layers or coatings may be employed as an outer-most layer in various other embodiments. The variable diameter sheath may be used to expand or contract the diameter of the stylus in some disclosed embodiments.

In certain embodiments the variable diameter grip or variable diameter sheath may have a first diameter when the expandable diameter stylus is positioned within a stylus garage of a portable computing system. The variable diameter grip or variable diameter sheath may have a second diameter, larger than the first diameter, when the stylus is removed from the stylus garage for use as an input device. The larger grip may provide a more comfortable use diameter for a user of the stylus or pen as an input device. Similarly, the variable diameter sheath may be adjusted to have a second diameter, larger than the first diameter, when the stylus is removed from the stylus garage for use as an input device. The larger variable diameter sheath may similarly provide a more comfortable use diameter for a user of the stylus or pen as an input device.

The systems and methods disclosed herein are technically advantageous because they allows for a stylus device to be stored with a portable computing system while still allowing for an optimal diameter for use. Notably, the diameter of the stylus is variable between a thin diameter for storage in a garage or elsewhere on an information handling system, or a thicker diameter allowing a user to select varying diameters according to a user's preference.

Additionally, the various diameters which the stylus may take may be changed as the profile of portable computing devices change in a variety of embodiments. This may allow for a stylus that can be scaled to the profile of any portable computing device, while still providing user conformability. Other technical advantages will be apparent to those of ordinary skill in the art in view of the following specification, claims, and drawings.

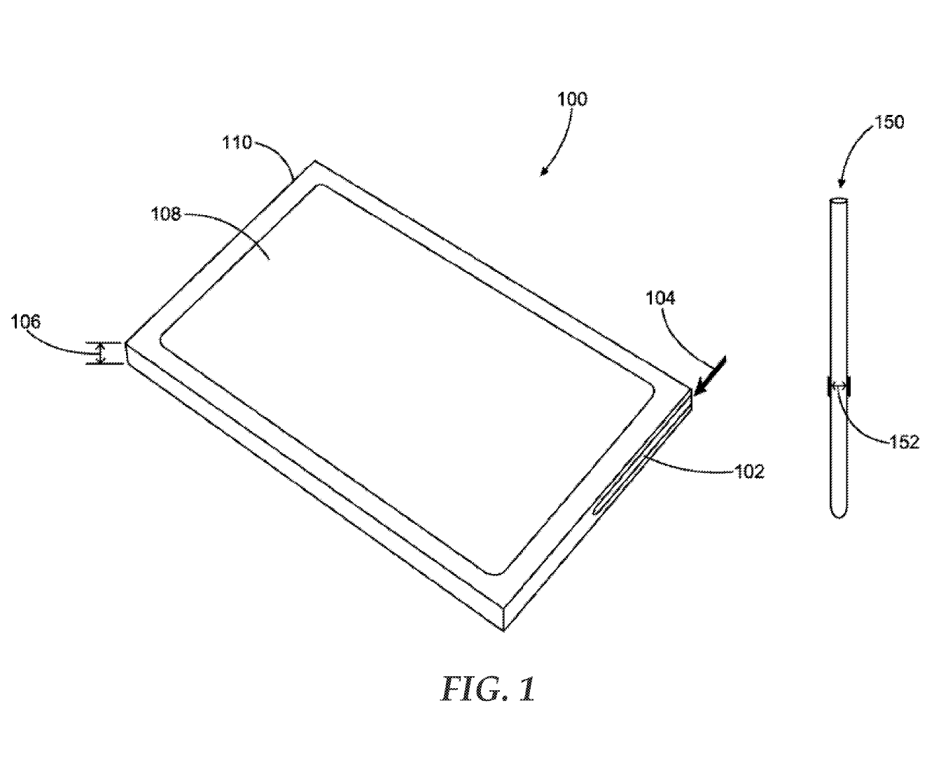

FIG. 1 shows a diagram of a typical portable computing system or information handling system 100. As used herein, the terms computing system, computing device, and information handling system may be used interchangeably. A portable computing system may comprise a computing system that is intended for use away from a fixed location, including but not limited to a notebook computer, a tablet computer, and a smartphone, i.e. a mobile phone with a mobile operating system. The portable computing system 100 may include a frame 110 positioned around a screen 108. The screen 108 may be touch-sensitive or otherwise respond to a stylus input device 150. The frame 110 may include a hollow portion or garage 102 in which the stylus 150 may be stored. Stylus or pen 150 may be garaged in a variety of ways including sliding into the garage as shown at 104. As will be appreciated by one of ordinary skill in view of this disclosure, the diameter of the garage 102 may be limited by the thickness 106 of the portable computing system 100.

Portable computing systems like portable computing system 100 have been trending toward a smaller thickness 106 to increase portability. Future thicknesses of five millimeters are possible. Given the space limitations, the diameter 152 of the stylus 150 may also be reduced. With a typical diameter of a writing instrument being around eight to nine millimeters, reducing the diameter to five millimeters or less will likely come at the expense of usability and comfortability.

According to aspects of the present disclosure, a plurality of expandable diameter styluses is disclosed herein. As will be appreciated by one of ordinary skill in the art, the expandable diameter of the stylus may accommodate the narrower profile of portable information handling system while still allowing comfortable use with the portable computing system.

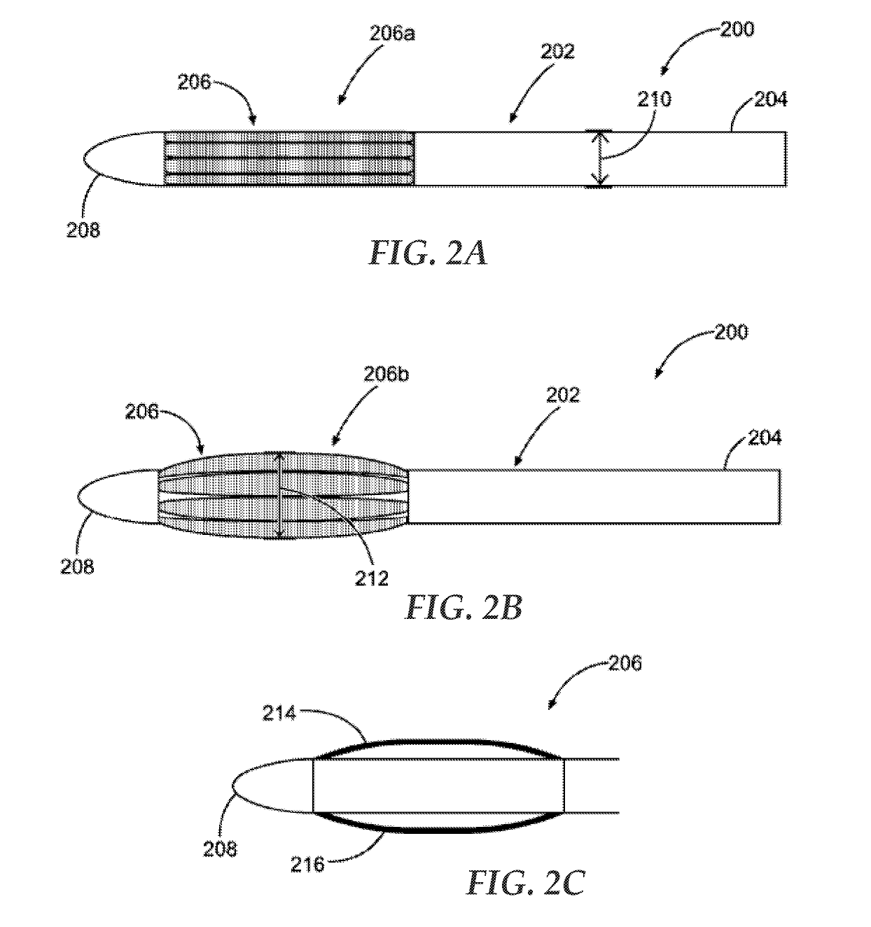

FIGS. 2A, 2B, and 2C are diagrams showing an expandable diameter stylus 200 according to aspects of the present disclosure. The stylus 200 may comprise an elongated body 202. The elongated body 202 may comprise a fixed diameter portion 204 and a variable diameter portion 206. In certain embodiments the elongated body 202 may comprise a unitary piece, with the fixed diameter portion 204 and the variable diameter portion 206 formed as an integral element. In certain other embodiments, the fixed diameter portion 204 and the variable diameter portion 206 may be manufactured as at least two separate pieces that can be coupled together, such as by a threaded connection.

The stylus 200 may further comprise a writing surface 208 disposed on an end of the elongated body 202. The writing surface 208 may be, for example, formed integrally with the elongated body 202, or manufactured separately and coupled to the elongated body 202. In the embodiment shown, the writing surface 208 is disposed at an end of the elongated body 202 proximate to the variable diameter portion 206. The writing surface 208 may comprise a soft foam-type material to protect the screen of a portable computing device. Other materials may also be used, as will be appreciated by one of ordinary skill in view of this disclosure.

In the embodiment shown, the variable diameter portion 206 comprises a variable diameter grip. The grip may be positioned proximate to the writing surface 208. The fixed diameter portion 204 may have a first diameter 210, and the variable diameter portion 206 may expand from the first diameter 210 to a second diameter 212, larger than the first diameter 210.

Although two diameters are shown, an expandable diameter stylus may have a plurality of diameters within the scope of this disclosure, and the embodiments shown are not limited to only two diameters. FIG. 2A shows the variable diameter grip 206 in a first position 206a, where the diameter of the variable diameter grip 206 is the first diameter 210, substantially the same as the fixed diameter portion 204. In contrast, HG. 2B shown the variable diameter grip 206 in a second position 206b, where the diameter of the variable diameter grip is a second diameter 212, larger than the first diameter 210.

In certain embodiments, the variable diameter grip 206 may comprise a rubberized covering disposed around a spring element 214 that may be configured to place the variable diameter grip in the first position 206a or the second position 206b, depending on the exterior forces applied to the variable diameter grip 206. Spring element 214 is shown in an example embodiment of FIG. 2C. Other spring elements may be configured to place the variable diameter grip 206 in a plurality of positions with a plurality of possible diameters. The spring element 214 may be in a compressed state when the variable diameter grip 206 is in the first position 206a and has the first diameter 210, and may be in an expanded position when the variable diameter portion 206 is in the second position 206b and has the second diameter. For example, the spring element 214 may comprise at least one leaf spring 216. In the embodiment shown, the spring element 214 comprises a plurality of leaf springs spaced radially around the elongated body 202. The leaf spring 216 may curve outwards from the elongated body 202 when relaxed, or not compressed, and may lay flat against the elongated body 202 when the leaf spring is compressed.

In certain embodiments, the spring element 214 may be compressed when the stylus 200 is inserted into a garage within a portable computing system, such as portable computing system 100 in FIG. 1. The force required to insert the stylus 200 in the garage combined with the narrow diameter of the garage may impart a compressive force of the variable diameter grip 206, causing the spring element 214 to compress and the variable diameter grip 206 to be placed in first position 206a with the first diameter 210. When compressed, the entire elongated body 202 may have the same diameter and may fit within the narrow diameter garage.

Conversely, when the stylus 200 is removed from the garage, the compressive force may be removed, allowing the spring element 214 to expand into the second position 206b with the second diameter 212. Accordingly, the stylus 200 may have a diameter larger than a garage when the stylus 200 is removed for use, but may still fit within the garage for storage with a portable computing system when not in use.

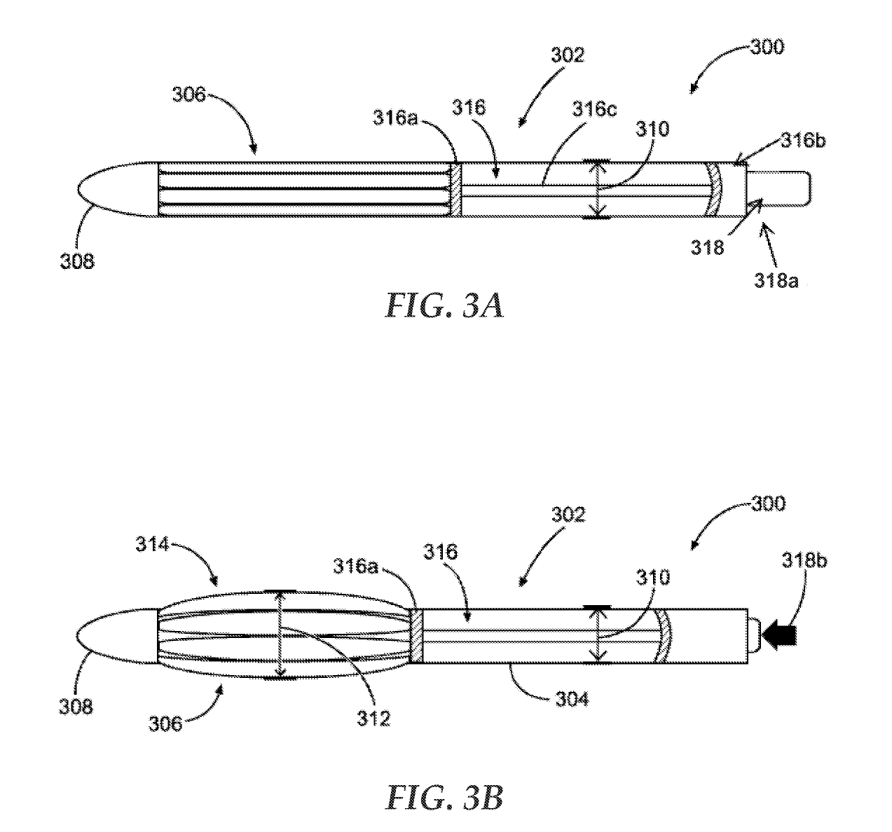

As will be appreciated by one of ordinary skill in the art in view of this disclosure, the stylus shown in FIGS. 2A-2C may expand automatically when removed from the garage. In certain embodiments, however, an expandable diameter stylus may be expanded manually. FIGS. 3A and 3B illustrate an example expandable diameter stylus 300 that may be manually expanded, without compressive forces from a garage. The stylus 300 may comprise an elongated body 302.

The elongated body 302 may comprise a fixed diameter portion 304 and a variable diameter portion 306. In certain embodiments, the elongated body 302 may comprise a unitary piece, with the fixed diameter portion 304 and the variable diameter portion 306 formed as an integral element. In certain other embodiments, the fixed diameter portion 304 and the variable diameter portion 306 may be manufactured as at least two separate pieces that can be coupled together, such as by a threaded connection.

The stylus 300 may further comprise a writing surface 308 disposed on an end of the elongated body 302. The writing surface 308 may be, for example, formed integrally with the elongated body 302, or manufactured separately and coupled to the elongated body 302. In the embodiment shown, the writing surface 308 is disposed at an end of the elongated body 202 proximate to the variable diameter portion 306. The writing surface 308 may comprise a soft foam-type material to protect the screen of a tablet-like portable computing device. Other materials may also be used, as will be appreciated by one of ordinary skill in view of this disclosure.

In the embodiment shown, the variable diameter portion 306 comprises a variable diameter grip. The grip may be positioned proximate to the writing surface 308. The fixed diameter portion 304 may have a first diameter 310, and the variable diameter portion 306 may expand from the first diameter 310 a second diameter 312, larger than the first diameter 310.

FIG. 3A shows the variable diameter grip 306 in a first position, where the diameter of the variable diameter grip 306 is the first diameter 310, substantially the same as the fixed diameter portion 304. In contrast, FIG. 3B shown the variable diameter grip 306 in a second position, where the diameter of the variable diameter grip is a second diameter 312, larger than the first diameter 310.

In certain embodiments, the variable diameter grip 306 may comprise a spring element 314 that may be configured to place the variable diameter grip in the first position or the second position, or a plurality of other diameters depending on the configuration.

The spring element 314 may comprise at least one plastic strip that is not compressed when the variable diameter portion 306 is in a first position and is compressed with the variable diameter portion 306 is in a second position. In the embodiment shown, the variable diameter portion 306 comprises a plurality of plastic strips radially spaced around the elongated body 302. The plastic strips may be positioned proximate to a locking mechanism 316. Specifically, the locking mechanism 316 may include a plunger 316a coupled to cam structure 316b via shaft 316c. The locking mechanism may be externally actuated by button 318 disposed on an end of the elongated body 302.

Unlike stylus 200, where a compressive force from a garage in a portable computer may cause the diameter of the variable diameter portion to change, the diameter of the variable diameter grip 306 may be altered using the locking mechanism 316. Specifically, when the button 318 is in position 318a, the locking mechanism 316 may be unlocked, the plastic strips may be in a relaxed state, and the variable diameter portion 306 may have the first diameter 310, substantially the same as the fixed diameter portion 302. In contrast, when the button 318 is in position 318b, the locking mechanism 316 may be locked, the plastic strips may be in a compressed state, and the variable diameter portion 306 may have the second diameter 312. Notably, by pressing the button 318 toward the elongated body 302, the locking mechanism 316 may be toggled between an unlocked state and a locked state. Accordingly, a user may manually select the diameter of the expandable diameter stylus.

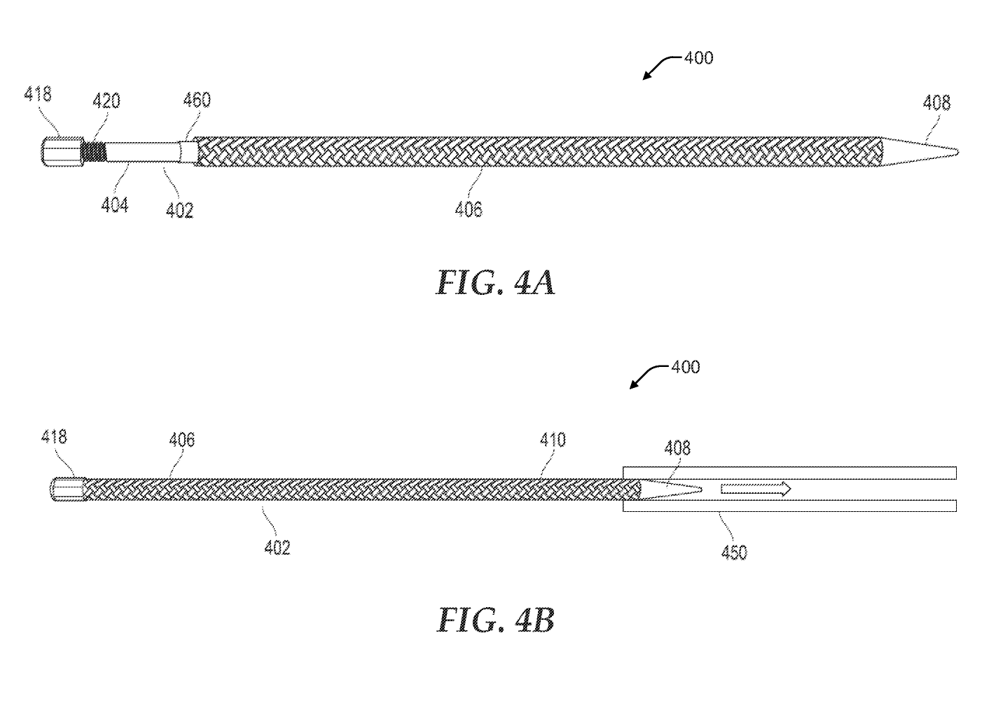

FIGS. 4A, 4B and 4C illustrate another example variably expandable diameter stylus 400 that may be manually expanded, without compressive forces from a garage. The stylus 400 may comprise an elongated body 402. The elongated body 402 may comprise an inner stylus shaft 404 and a variable diameter sheath 406 that comprises a variable diameter portion. In a shown embodiment, the variable diameter sheath 406 is an outer sheath around the elongated body 402. In certain embodiments, the elongated body 402 may comprise a unitary piece, with the fixed diameter inner stylus shaft 404 and the variable diameter sheath portion 406 formed as an integral element. In certain other embodiments, the fixed diameter inner stylus shaft 404 and the variable diameter sheath portion 406 may be manufactured as at least two separate pieces that can be coupled together, such as by a fused connection, threaded connection, a ring fastener or via other types of fasteners that will be appreciated by one of ordinary skill in view of this disclosure.

Variable diameter sheath 406 may be operatively connected at one end to an inner shaft 404 and slidingly coupled to an actuating mechanism at another end of variable diameter sheath 406. The actuating mechanism may in an embodiment be an endcap 418 as shown in the disclosures or may be a writing surface 408 or another actuating cuff or ring (not shown) located along the elongated body 402. One end of the variable diameter sheath 406 may be fixedly connected to the inner shaft 404, endcap 418, or writing surface 408 in some embodiments. Other embodiments may are also contemplated where actuation of the length of variable diameter sheath 406 may be available on both ends.

The stylus 400 may further comprise a writing surface 408 disposed on an end of the elongated body 402. The writing surface 408 may be, for example, formed integrally with the elongated body 402, or manufactured separately and coupled to the elongated body 402. In the embodiment shown, the writing surface 408 is disposed at an end of the elongated body 402 proximate to the attachment of one end of variable diameter sheath 406 to inner stylus shaft 404. In some aspects, this attachment may be integrated with the writing surface 408. In additional aspects of the present disclosure, the writing surface may be attached to the inner stylus shaft via a threaded engagement or other engagement and attached to the variable diameter sheath 406. The writing surface 308 may be actuated by a twist, push or other mechanism to engage the variable diameter sheath 406 to adjust its length relative to another connection point on the inner stylus shaft 404. In other aspects, connection of the variable diameter sheath 406 to the inner stylus shaft may be fixed at the writing surface 408. In yet other embodiments, the attachment of variable diameter sheath 406 to the inner stylus shaft 404 may be located further up the inner stylus shaft from the writing surface 408 as one or ordinary skill in the art would appreciate in view of this disclosure. The writing surface 408 may comprise a soft foam-type material to protect the screen of a tablet-like portable computing device. Other materials may also be used such as smooth materials for ease of stylus use, as will be appreciated by one of ordinary skill in view of this disclosure. In one aspect of the present embodiments, stylus 400 has an endcap 418. Endcap 418 may be integrated into inner stylus shaft 404 in some embodiments such as when variable diameter sheath 406 is fixedly attached to inner stylus shaft 404 at an end proximate to endcap 418.

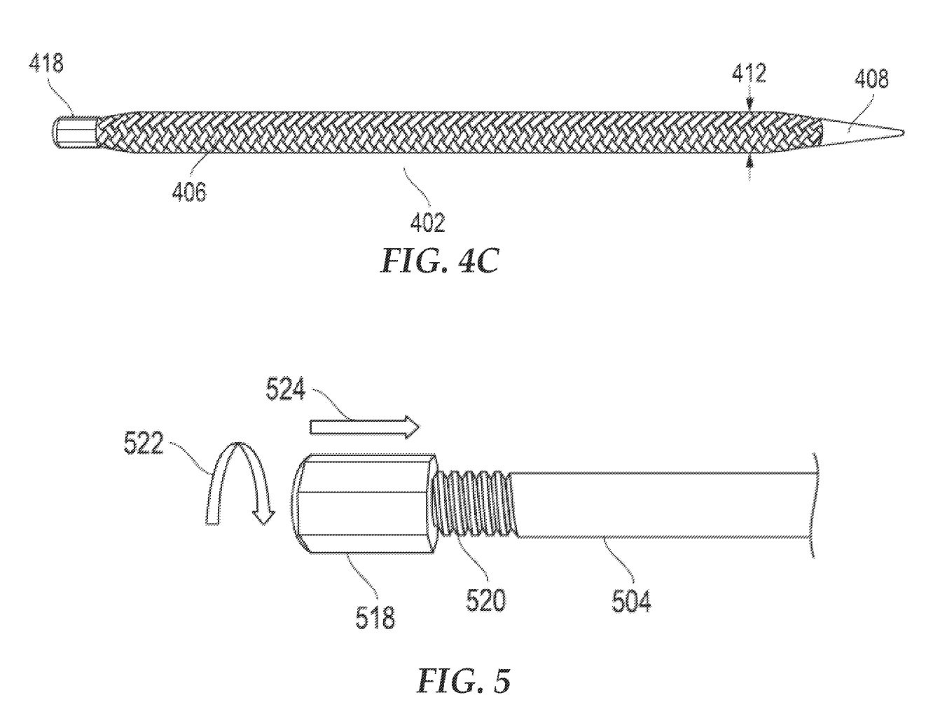

In some embodiments, such as shown in FIG. 5, endcap 518 is attached via a helical engagement or other variable engagement and may be used to shorten the length of variable diameter sheath 406 with respect to another end of variable diameter sheath 406 attached to inner stylus shaft 504. Shown in one embodiment of in FIG. 5, inner stylus shaft 504 has helical threads 520 which may be used to connect endcap 518. Rotation 522 may engage helical threads 520 and cause endcap 518 to move inwardly as in 524. This inward movement 524 will cause a variable diameter sheath 406 attached to or pressed against endcap 518 to be pushed inwardly shortening its length relative to a connection point at the other end of variable diameter sheath 406. This will cause variable diameter sheath 406 to thicken in diameter. Other methods of actuating endcap 518 may be used as well including a plunger system where endcap 518 is pushed inwardly to engage at a shorter position and endcap 518 moves inwardly as in 524 pushing variable diameter sheath 406 inwardly as before resulting in a shorter and thicker variable diameter sheath 406. Specifically, a locking mechanism similar to that described in FIG. 3 or a similar system, may include a plunger coupled to cam structure via an internal shaft. As the endcap is depressed, the edge of the endcap, a ring, cuff, or other engaging mechanism may push the variable diameter sheath 406 to shorten its length with respect to a fixed end. The locking mechanism may be externally actuated by endcap 418 acting as a button disposed on an end of the elongated body 402. The locking mechanism may be toggled between an unlocked state and a locked state to change the length variable diameter sheath 406. In another embodiment, the endcap may have a twist and lock mechanism to lock the endcap with respect to an inner shaft. Similar to other embodiments, the endcap edge, a ring, cuff, or other engaging mechanism may actuate the variable diameter sheath 406 to shorten its length.

In the embodiment shown in FIGS. 4A-4C, the variable diameter sheath 406 of this disclosure a helically wound braid of a material comprising a plurality of strands or strips of material. In one embodiment of the present disclosures, the variable diameter sheath 406 is of a cylindrical shape. Other braided shapes are contemplated as well including oval or shapes with one or more edges lengthwise. In one example embodiment, a biaxial braid may be used, but it is appreciated that a variety of braids for material types may be used to form a variable diameter sheath 406. A variety of materials may be used as well including strips or strands of a metallic or quasi-metallic material, plastic strips or strands, or strips or strands of other natural or artificial materials such as strips or fibers from plants such as bamboo, wood, polyester, or other known materials suitable for a helical weave. Multiple materials may be used and weaved together in some aspects of the disclosures as well. The variable diameter sheath 406 may be positioned along nearly the entire length of the inner stylus shaft 404 or may be positioned along any portion of the same. In a fully extended length, the variable diameter sheath 406 over the inner stylus shaft 404 may have a first diameter 410 shown in FIG, 4B. The variable diameter sheath 406 may expand from the first diameter 410 to a second diameter 412 shown in FIG. 4C, larger than the first diameter 410. At diameter 410, stylus 400 may fit into a housing 450, such as a stylus garage, as depicted in FIG. 4B. In other embodiments, stylus 400 at diameter 410 may better fit attached to or stored along an edge of a portable computing system.

Also shown in FIG. 4A according to some embodiments, inner stylus shaft 404 may hay one or more intervening sheath layers 460 between itself and variable diameter sheath 406. Intervening sheath layer 460 may be of a compressible material to allow the space between the inner stylus shaft 404 and the variable diameter sheath 406 to be filled to avoid any sagging or looseness. In an alternate embodiment, a compressible coating or layer may be applied to inner stylus shaft 404 in lieu of or in addition to an intervening sheath layer 460. Example materials that may be used for an intervening sheath layer or coating 460 may include compressible materials such as neoprene, foam materials, and other artificial or natural materials of suitable compressibility. Intervening sheath layers 460 may cover much of the length of inner stylus shaft 404, or may only cover any portion of the same. In other embodiments, the materials selected may provide stiffness to avoid sag or looseness when variable diameter sheath 406 is shortened and thickened. For example, braided steel weave may be used in an embodiment that gives rigidity even after it is expanded in diameter. In other embodiments, a combination of strategies may be employed to avoid looseness or sag.

In certain embodiments, the variable diameter sheath 406 may comprise a spring element under the variable diameter sheath 406 that may be configured to place an expanding force on all or part of the variable diameter sheath 406 when it is compressed and thickened depending on the configuration.

Notably, by pressing or turning endcap 418 toward the elongated body 402, the variable diameter sheath 406 may be variably changed in length and thickness due to the helical weave structure. Accordingly, a user may manually select the diameter of the expandable diameter stylus.

Although the styluses described above include a variable diameter portion, other embodiments are possible within the scope of this disclosure. For example, in certain embodiments, the diameter of the entire stylus may expand together, without a fixed diameter portions. Additionally, other spring elements may be used, as can other elements used to manually select the diameter of the expandable diameter stylus. Likewise, in certain embodiments, the expandable diameter stylus may have varying degrees of diameter expansion, controlled by the user—so that the diameter can be set to whatever is comfortable according to individual preference.

According to aspects of the present disclosure, a method for providing an input device for a portable computing system is described herein. The method may include, providing a portable computing system, wherein the portable computing system includes a stylus garage. The portable computing system and stylus garage may be similar to those described above with respect to FIG. 1. The method may also include providing an expandable diameter stylus. As is also described above, the expandable diameter stylus may be configured to have a first diameter when the expandable diameter stylus is positioned within the stylus garage, and have a second diameter, larger than the first diameter, when the expandable diameter stylus is outside of the garage. The second diameter may be larger than the first diameter, and the expandable diameter stylus may expand to the second diameter either automatically or manually when the stylus is removed from the garage. The second diameter may be one of a plurality of diameters of the expandable diameter pen, either pre-set by the expansion mechanism of the stylus, or selectable by a user according to individual preference.

According to aspects of the present disclosure, a system comprising a portable computing device is also disclosed herein. The system may further include a stylus garage disposed within the portable computing device. Additionally, the system may include an expandable diameter stylus similar to those described above. The expandable diameter stylus may be configured to have a first diameter when the expandable diameter stylus is positioned within the garage and a second diameter when the expandable diameter stylus is positioned outside of the garage. The second diameter may be larger than the first diameter, and the expandable diameter stylus may expand to the second diameter either automatically or manually when the stylus is removed from the garage.

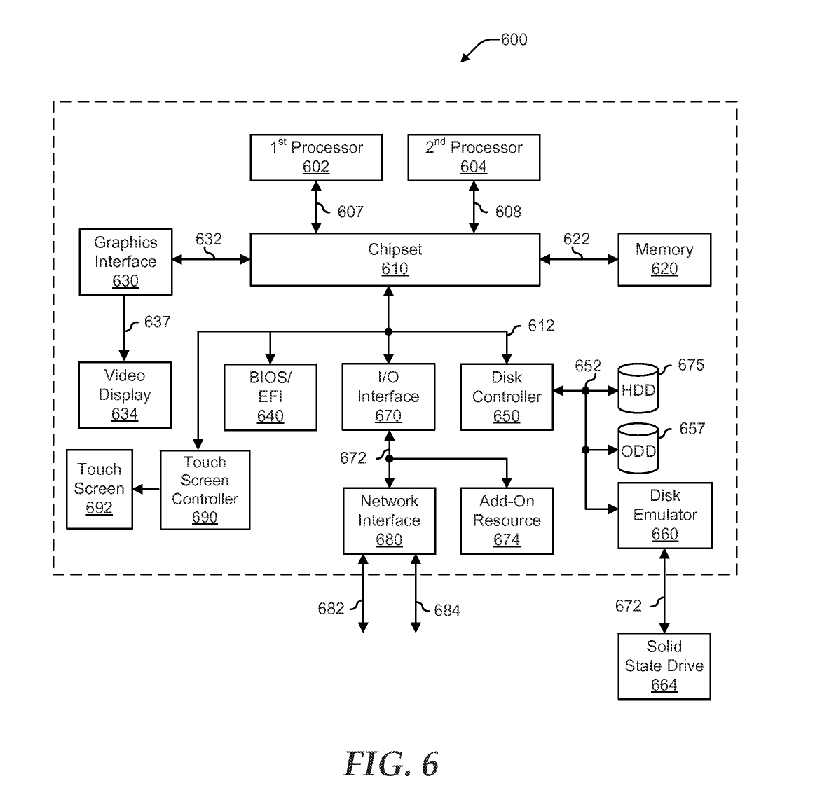

FIG. 6 illustrates a generalized embodiment of information handling system 600. Information handling system 600 can include devices or modules that embody one or more of the devices or modules described above, and operates to perform one or more of the methods described above. Information handling system 600 includes a processors 602 and 604, a chipset 610, a memory 620, a graphics interface 630, include a basic input and output system/extensible firmware interface (BIOS/EFI) module 640, a disk controller 650, a disk emulator 660, an input/output (I/O) interface 670, a network interface 680, and a touchscreen controller 690. Processor 602 is connected to chipset 610 via processor interface 607, and processor 604 is connected to chipset 610 via processor interface 608. Memory 620 is connected to chipset 610 via a memory bus 622. Graphics interface 630 is connected to chipset 610 via a graphics interface 632, and provides a video display output 637 to a video display 634. In a particular embodiment, information handling system 600 includes separate memories that are dedicated to each of processors 602 and 604 via separate memory interfaces. An example of memory 620 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 640, disk controller 650, and I/O interface 670 are connected to chipset 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 640 includes BIOS/EFI code operable to detect resources within information handling system 600, to provide drivers for the resources, initialize the and access the resources. BIOS/EFI module 640 includes code that operates to detect resources within information handling system 600, to provide drivers for the resources, to initialize the resources, and to access the resources.

Disk controller 650 includes a disk interface 652 that connects the disk controller to a hard disk drive (HDD) 675, to an optical disk drive (ODD) 657, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits a solid-state drive 664 to be connected to information handling system 600 via an external interface 662. An example of external interface 662 includes a USB interface, an IEEE 7194 (Firewire) interface, a proprietary interface, or a combination thereof. Alternatively, solid-state drive 664 can be disposed within information handling system 600.

I/O interface 670 includes a peripheral interface 672 that connects the I/O interface to an add-on resource 674 and to network interface 680. Peripheral interface 672 can be the same type of interface as I/O channel 612, or can be a different type of interface. As such, I/O interface 670 extends the capacity of I/O channel 612 when peripheral interface 672 and the I/O channel are of the same type, and the I/O interface translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as chipset 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Touch screen controller 690 may be connected to chipset 610 via I/O channel 612 or via another connection (not shown). Touch screen controller 690 may receive inputs from touch screen 692. Touch screen 692 may be a capacitive touch screen, resistive touch screen or may be of other styles known in the art. Touch screen 692 may receive touch inputs from a finger, stylus, pen, or other interactive implement of a user. For example, the stylus embodiments of the present disclosures may be used with the touch screen 692. Additionally, touch screen stylus or other implements may be passive or active in various embodiments. For example, touch screen 692 may also have interactive components and may be used with an active stylus or other input device for use with touch screen 692.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (CPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card international Association (PCMCIA) card, or other such expansion card), or a system (such as a motherboard, a system-on-a-chip (SoC), or a stand-alone device).

The device or module can include software, including firmware embedded at a device, such as a Pentium class or PowerPCT™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Accordingly, a system is described in which a pointer provides input through a user interface for an information handling system (e.g., a desktop computer). The user interface may be presented through an operating system or application running on the information handling system. An application (e.g., a computer program) receives and processes user input provided through the pointer. In accordance with disclosed embodiments, the context associated with the application and the type of input received may both dictate the feedback provided to the user. For example, an application (e.g., computer program) may permit note-taking on a simulated chalkboard with chalk. Accordingly, the context in such a system would be chalk writing. A sub context may be identified as scribbling on a chalkboard. An embodied system receives user input from a pointer that is relevant to the context, and provides feedback (e.g., tactile feedback or audible feedback) that is tuned realistically and dynamically according to measured characteristics of the user input. For example, an embodied system may detect for a pencil-paper handwriting application that the relatively quick speed of a user's input requires increasing the playback speed for audio data associated with the context of pencil-paper handwriting

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Although the present disclosure has been described in detail, it should be understood that various changes, substitutions, and alterations can be made hereto without departing from the spirit and the scope of the invention as defined by the appended claims. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. An expandable diameter stylus comprising:
an elongated body;
a writing surface disposed on an end of the elongated body; and
a variable diameter sheath including a helical weave along at least a portion of the elongated body.

2. The expandable diameter stylus of claim 1, wherein the elongated body comprises a fixed diameter inner shaft and the variable diameter sheath is in a stretched position having a first diameter.

3. The expandable diameter stylus of claim 1, wherein the variable diameter sheath is proximate to an endcap to adjust the length of the variable diameter sheath.

4. The expandable diameter stylus of claim 3, wherein the variable diameter sheath is configured to have a second diameter, larger than the first diameter, when the endcap is actuated toward the writing surface.

5. The expandable diameter stylus of claim 1, wherein the variable diameter sheath is operatively connected to the writing surface.

6. The expandable diameter stylus of claim 1, wherein the variable diameter sheath is proximate to the writing surface which may be actuated to adjust the length of the variable diameter sheath.

7. The expandable diameter stylus of claim 3, further comprising a locking mechanism operatively coupled to the endcap wherein the variable diameter sheath is configured to have a second diameter, larger than the first diameter, when the locking mechanism is in a locked position.

8. The expandable diameter stylus of claim 1, further comprising a compressible intervening layer or a compressible intervening coating operatively coupled between an inner shaft of the elongated body and the variable diameter sheath.

9. The expandable diameter stylus of claim 1, wherein the helical weave of the variable diameter sheath further comprises a braided steel weave.

10. A method for providing an input device for a portable computing system, comprising:
providing the portable computing system, wherein the portable computing system includes a stylus garage;
providing an expandable diameter stylus having a variable diameter sheath including a helical weave, wherein the expandable diameter stylus is configured to:
have a first diameter when the expandable diameter stylus is positioned within the stylus garage; and
expand to a second diameter, larger than the first diameter, upon inward actuation shortening the helical weave variable diameter sheath.

11. The method of claim 10, wherein expandable diameter stylus further comprises: an elongated body; a writing surface disposed on an end of the elongated body; and a first end of the variable diameter sheath that is proximate to the writing surface.

12. The method of claim 11, wherein a second end the variable diameter sheath is proximate to an endcap.

13. The method of claim 12, wherein an endcap is actuate toward the writing surface to shorten the variable diameter sheath to the second diameter.

14. The method of claim 13, wherein the endcap is actuated away from the writing surface to lengthen the variable diameter sheath to the first diameter.

15. The method of claim 12, wherein the writing surface is actuated toward an endcap to shorten the variable diameter sheath to the second diameter.

16. The method of claim 12, further comprising a lockable plunger operatively coupled to the endcap for adjusting the length of the variable diameter sheath.

17. The method of claim 16, further comprising a compressible intervening layer or a compressible intervening coating operatively coupled between an inner shaft and the variable diameter sheath to support the shape of the expandable diameter stylus at a second diameter.

18. A system comprising:
a portable computing device;
a stylus garage disposed within the portable computing device;
an expandable diameter stylus having an elongated body;
a writing surface disposed on an end of the elongated body; and
variable diameter sheath including a helical weave along at least a portion of the elongated body,
wherein the expandable diameter stylus is configured have a first diameter when the expandable diameter stylus is positioned within the stylus garage.

19. The system of claim 18, wherein the expandable diameter stylus is configured to expand to a second diameter, larger than the first diameter, upon inward actuation shortening the variable diameter sheath when removed from the garage.

20. The system of claim 18, wherein the expandable diameter stylus is configured to be manually expanded a plurality of available diameters depending upon an amount of inward actuation shortening the variable diameter sheath.
